(19) United States
(12) Patent Application Publication
(10) Pub. No.: US 2025/0210615 A1
(43) Pub. Date: Jun. 26, 2025

(54) ELECTRODE FILM MANUFACTURING METHOD, ELECTRODE FILM, AND BATTERY

(71) Applicant: TOYOTA JIDOSHA KABUSHIKI KAISHA, Toyota-shi Aichi-ken (JP)

(72) Inventors: Shinji KOJIMA, Nagoya-shi Aichi-ken (JP); Masashi UEDA, Toyota-shi Aichi-ken (JP); Tomoko HIGO, Toyota-shi Aichi-ken (JP)

(73) Assignee: TOYOTA JIDOSHA KABUSHIKI KAISHA, Toyota-shi Aichi-ken (JP)

(21) Appl. No.: 18/950,739

(22) Filed: Nov. 18, 2024

(30) Foreign Application Priority Data
Dec. 22, 2023 (JP) 2023-217429

(51) Int. Cl. H01M 4/04; H01M 4/02; H01M 4/62

(52) U.S. Cl. CPC H01M 4/04; H01M 4/623; H01M 2004/021

(57) ABSTRACT

An electrode film manufacturing method includes performing adhesion of polyvinylidene difluoride to active material particles, mixing the active material particles, to which the polyvinylidene fluoride adheres, with polytetrafluoroethylene to obtain a mixture, and fiberizing the polytetrafluoroethylene in the mixture. A process of the fiberization is carried out at a temperature of 50° C. or higher, and the mixture does not contain a solvent.

### CROSS-REFERENCE TO RELATED APPLICATION

This application claims priority to Japanese Patent Application No. 2023-217429 filed on Dec. 22, 2023, incorporated herein by reference in its entirety.

### BACKGROUND

### 1. Technical Field

The present disclosure relates to an electrode film manufacturing method, an electrode film, and a battery.

### 2. Description of Related Art

Batteries such as lithium-ion secondary batteries or the like use electrodes in a state in which active material particles are fixed to a surface of a current collector, such as a metal foil or the like, by a binder. Known methods for manufacturing electrodes include a method in which a composition, prepared by mixing active material particles and a binder with a solvent, is applied to a surface of a current collector (also known as a wet method), and a method in which active material particles are fixed to a current collector with a binder without using a solvent (also known as a dry method).

As a method for manufacturing an electrode by a dry process, a method has been proposed in which a resin, which has properties of fiberization (also known as a fibrillation) when shear force is applied, is used as a binder. For example, Japanese Unexamined Patent Application Publication No. 2022-3694 (JP 2022-3694 A) describes a method of fabricating an electrode film by fiberization of polytetrafluoroethylene (PTFE) in a mixture containing active material particles and PTFE, and then integrating this electrode film with a current collector to manufacture an electrode.

### SUMMARY

JP 2022-3694 A describes that a calendaring process for fabricating an electrode film containing fiberized PTFE may be performed at a temperature of 10° C. to 300° C., but relations between physical properties of the electrode film and temperature conditions of the calendaring process are not studied. One embodiment of the present disclosure provides an electrode film manufacturing method of an electrode film having desirable tensile strength, the electrode film having desirable tensile strength, and a battery including the electrode film having desirable tensile strength.

The present disclosure includes the following embodiments. A first aspect of the present disclosure is an electrode film manufacturing method, including performing adhesion of polyvinylidene difluoride to active material particles, mixing the active material particles, to which the polyvinylidene difluoride is adhered, with polytetrafluoroethylene to obtain a mixture, and fiberizing the polytetrafluoroethylene in the mixture. The fiberizing is carried out at a temperature of 50° C. or higher, and the mixture does not contain a solvent.

In the electrode film manufacturing method according to the first aspect of the present disclosure, the fiberizing may be carried out at a temperature of 100° C. or higher.

In the electrode film manufacturing method according to the first aspect of the present disclosure, the fiberizing may be carried out at a temperature of 200° C. or lower.

In the electrode film manufacturing method according to the first aspect of the present disclosure, the fiberizing may be carried out at a temperature of 180° C. or lower.

In the electrode film manufacturing method according to the first aspect of the present disclosure, the fiberizing may include fashioning the mixture into a film.

In the electrode film manufacturing method according to the first aspect of the present disclosure, an amount of the polyvinylidene difluoride relative to an amount of the active material particles may be no less than 1% by mass and no more than 10% by mass relative to 100 parts by mass of the active material particles.

In the electrode film manufacturing method according to the first aspect of the present disclosure, an amount of the polytetrafluoroethylene relative to an amount of the active material particles may be no less than 1% by mass and no more than 10% by mass relative to 100 parts by mass of the active material particles.

A second aspect of the present disclosure is an electrode film including active material particles, polyvinylidene difluoride adhering to the active material particles, and polytetrafluoroethylene that is fibrous.

In the electrode film according to the second aspect of the present disclosure, a count of strands of the polytetrafluoroethylene that is fibrous, intersecting a straight line of a length of 20 μm situated at any position on an image of a cross-section of the electrode film, may be no less than five.

In the electrode film according to the second aspect of the present disclosure, the count of strands of the polytetrafluoroethylene that is fibrous, intersecting the straight line, may be no less than 20.

In the electrode film according to the second aspect of the present disclosure, at least a part of the polytetrafluoroethylene that is fibrous may adhere to the active material particles.

In the electrode film according to the second aspect of the present disclosure, coverage of surfaces of the active material particles by the polyvinylidene difluoride may be no less than 5%.

A third aspect of the present disclosure is a battery including the electrode film according to the second aspect of the present disclosure.

According to an embodiment of the present disclosure, there are provided an electrode film manufacturing method of an electrode film having desirable tensile strength, the electrode film having desirable tensile strength, and a battery including the electrode film having desirable tensile strength.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a diagram schematically illustrating an example of a laminated structure of an electrode body included in a battery; and

FIG. 2 is a scanning electron microscope (SEM) image of a cross-section of an electrode film (rolling processing performed at 150° C.) fabricated in an Example.

### DETAILED DESCRIPTION OF EMBODIMENTS

In the present disclosure, numerical value ranges indicated using “to” means a range that includes numerical values before and after the “to” as the minimum value and the maximum value, respectively. In the present disclosure, in which numerical value ranges are described in stages, an upper limit value or a lower limit value described in a certain numerical value range may be replaced with an upper limit value or a lower limit value of another numerical value range described in stages. In the numerical value ranges described in the present disclosure, an upper limit value or a lower limit value described in a certain numerical value range may be replaced with a value shown in the Examples. In the present disclosure, the term “process” refers not only to an independent process, but also to a process that cannot be clearly distinguished from other processes, as long as the intended purpose of the process is achieved. In the present disclosure, a combination of two or more forms is a more desirable form. In the present disclosure, when there are multiple substances corresponding to each component, the amount of each component means the total amount of multiple substances, unless otherwise specified.

### Electrode Manufacturing Method

An electrode film manufacturing method according to the present disclosure includes performing adhesion of polyvinylidene difluoride (hereinafter also referred to as “PVdF”) to active material particles, mixing the active material particles with PVdF adhering thereto with polytetrafluoroethylene (PTFE) to obtain a mixture, and fiberizing the PTFE in the mixture, in which the process of fiberization is carried out at a temperature of 50° C. or higher, and the mixture does not contain a solvent.

In the present disclosure, “electrode film” refers to a film-like object that contains a substance that functions as an active material of an electrode, and that is in a self-supporting state (i.e., capable of maintaining its shape without a support). The electrode film is used as an active material layer disposed on one or both sides of a current collector, for example. The method according to the present disclosure does not use a solvent in manufacturing the electrode film. Accordingly, the method according to the present disclosure has desirable affinity with respect to living organisms and the environment. Furthermore, a process of volatilization of the solvent following film formation can be omitted from the method according to the present disclosure, and therefore has desirable manufacturing efficiency.

The electrode film manufactured by the method according to the present disclosure exhibits superior tensile strength compared to electrode films obtained by carrying out fiberization of PTFE at temperatures below 50° C. For example, the method according to the present disclosure enables manufacturing an electrode film having a tensile strength of 0.5 MPa or higher. An electrode film having a tensile strength of 0.5 MPa or higher is advantageous in that damage such as cracks is unlikely to occur during the manufacturing of the electrode film. The reason why the electrode film manufactured by the method according to the present disclosure exhibits desirable tensile strength is thought to be, for example, as follows. When fiberization of PTFE is performed at a temperature of 50° C. or higher, fiberization of PTFE is promoted. Furthermore, the PVdF adhering to the active material particles melts or softens, and the fiberized PTFE adheres to the active material particles via the melted or softened PVdF. It is thought that the tensile strength of the obtained electrode film is improved as a result of this.

Hereinafter, the process of adhesion of PVdF to active material particles will also be referred to as “Process 1,” the process of mixing the active material particles to which PVdF is made to adhere to PTFE to obtain a mixture will also be referred to as “Process 2,” and the process of fiberization of the PTFE in the mixture will also be referred to as “Process 3.”

### Process 1

In Process 1, PVdF is made to adhere to the active material particles. The method for adhesion of PVdF to the active material particles is not limited in particular, and can be carried out by a known method. For example, PVdF may be made to adhere to the active material particles by applying shear force to a mixture containing the active material particles and PVdF, using a device such as a mixer, a blender, a mill, or the like.

From the perspective of effective adhesion of the fiberized PTFE to the active material particles, in some embodiments, the amount of PVdF relative to the amount of the active material particles is no less than 1% by mass with respect to 100 parts by mass of the active material particles, no less than 2% by mass, or no less than 3% by mass. From the perspective of maintaining good electrode performance, in some embodiments, the amount of PVdF relative to the amount of the active material particles is no more than 10% by mass with respect to 100 parts by mass of the active material particles, no more than 8% by mass, or no more than 6% by mass.

The PVdF may be made to adhere to the entire surface of the active material particles, or may adhere to just a part of the surface of the active material particles. From the perspective of effective adhesion of the fiberized PTFE to the active material particles, in some embodiments, the coverage of the surface of the active material particles by PVdF is no less than 5%, no less than 10%, or no less than 15%. From the perspective of maintaining good electrode performance, in some embodiments, the coverage of the surfaces of the active material particles by PVdF is no more than 60%, no more than 50%, or no more than 40%.

In the present disclosure, the coverage of the surface of the active material particles by PVdF is measured by image analysis. An example of image analysis is a method of performing elemental mapping using energy-dispersive X-ray spectroscopy (EDX). Specifically, active material particles having PVdF adhering to the surfaces thereof are observed with a SEM (scanning electron microscope), and F-mapping is performed by EDX. A region X corresponding to the active material particles, and a region Y within the region X in which elements (F) contained in the PVdF exist, are binarized, and the coverage is calculated by the following Expression.

$$Coverage ( \% ) = ( area of Y / area of X ) \times 100$$

The type of active material particles used in the manufacturing of the electrode film may be an anode active material used in an anode, or a cathode active material used in a cathode.

Specific examples of the anode active material include carbon materials such as graphite, soft carbon, and hard carbon, silicon, and so forth.

Examples of the cathode active material include lithium transition metal composite oxides. Examples of the lithium transition metal composite oxides include layered lithium transition metal composite oxides, spinel-type lithium transition metal composite oxides, and olivine-type lithium transition metal composite oxides. Specific examples of layered lithium transition metal composite oxides include compounds represented by LiMO₂ (where M is at least one transition metal selected from a group consisting of Ni, Co, and Mn) and compounds in which a dissimilar element is added to this compound. Examples of dissimilar elements include Al, Mg, La, Ti, Zn, B, W, Fe, Cr, V, Ru, Cu, Cd, Ag, Y, Sc, Ga, In, As, Sb, Pt, Au, Si, and so forth. Specific examples of spinel-type lithium transition metal composites oxides include LiMn₂O₄. Specific examples of olivine-type lithium transition metal composite oxides include LiMPO₄ (where M is Fe, Co, Ni, or Mn). The cathode active material contained in cathode material may be one type alone, or two or more types.

Out of the lithium transition metal composite oxides, in some embodiments, a layered lithium transition metal composite oxide containing at least one type selected from Ni, Co, and Mn as the transition metal is selected, in some embodiments, a layered lithium transition metal composite oxide containing Ni and at least one type selected from Co and Mn as transition metals is selected, and, in some embodiments, a layered lithium transition metal composite oxide containing each of Ni, Co, and Mn as transition metals (lithium nickel cobalt manganese oxide (NCM)) is selected.

The active material particles used to manufacture the electrode film may be of one type alone or two or more types. The volume average particle size of the active material particles is not limited in particular and can be selected from a range of 5 μm to 30 μm, for example. In the present disclosure, the volume average particle size of particles is a value at which the cumulation from the small diameter side reaches 50% in a volume-based particle size distribution (D50), measured by laser diffraction and scattering.

In Process 1, a conductive aid may be made to adhere to the active material particles along with the PVdF. When the active material particles are cathode active material particles, in some embodiments, a conductive aid is made to adhere to the active material particles. Specific examples of the conductive aid include carbon materials such as carbon black (acetylene black, thermal black, furnace black, and so forth), carbon nanotubes, graphite, and the like.

The state in which the conductive aid adheres to the active material particles can be achieved, for example, by applying shear force to a mixture containing the active material particles, the conductive aid, and PVdF using a device such as a mixer, blender, mill, or the like.

### Process 2

In Process 2, the active material particles with PVdF adhering thereto are mixed with PTFE to obtain a mixture. The method for mixing the active material particles with PVdF adhering thereto with PTFE is not limited in particular, and can be carried out using known techniques.

From the perspective of maintaining the strength of the electrode film, in some embodiments, the amount of PTFE relative to the amount of the active material particles is no less than 1% by mass with respect to 100 parts by mass of the active material particles, no less than 2% by mass, or no less than 3% by mass. From the perspective of maintaining good electrode performance, in some embodiments, the amount of PTFE relative to the amount of the active material particles is no more than 10% by mass with respect to 100 parts by mass of the active material particles, no more than 8% by mass, or no more than 6% by mass.

The PTFE mixed with the active material particles in Process 2 may be in particulate form. The mixture obtained in Process 2 may contain a solvent, but does not have to contain a solvent. From the perspective of workability, in some embodiments, the mixture obtained in Process 2 does not contain a solvent. In Process 2, at least part of the PTFE may be fiberized. In this case, granules may be prepared in a state in which at least a portion of the active material particles are bound by the fiberized PTFE.

The mixture obtained in Process 2 may contain resins other than PVdF and PTFE. Specific examples of binders other than PVdF and PTFE include polyethylene, polypropylene, polyethylene terephthalate, cellulose, nitrocellulose, carboxymethyl cellulose, polyethylene oxide, polyepichlorohydrin, polyacrylonitrile, styrene-butadiene rubber (SBR), acrylonitrile-butadiene rubber (NBR), polyacrylate, polymethacrylate, and so forth.

When the mixture contains a resin other than PVdF and PTFE, the amount thereof may be no more than 20 parts by mass with respect to 100 parts by mass of the total of PVdF and PTFE, no more than 10 parts by mass, or no more than 5 parts by mass.

### Process 3

In Process 3, fiberization of the PTFE in the mixture obtained in Process 2 is performed. The PTFE in the mixture obtained in Process 2 is generally in a state in which the PTFE particles form agglomerates, and when shear force is applied, the agglomerates are destroyed and part of the particles change into a fibrous form. In the present disclosure, in addition to PTFE that is completely in a fibrous form, the part of the PTFE particles that have partly changed into a fibrous form is also defined as “fiberized PTFE.” The method for fiberization of PTFE is not limited in particular, and can be carried out using any known techniques capable of applying a shear force to PTFE.

Process 3 may include forming the mixture into a film. Examples of a method for forming the mixture into a film while performing fiberization of PTFE include rolling processing using a roll press machine.

In Process 3, the fiberization of PTFE is carried out at a temperature of 50° C. or higher. The above temperature is the temperature of equipment used for fiberization of the PTFE. For example, when fiberization of PTFE is carried out using a roll press machine, the above temperature is the surface temperature of the roll.

In some embodiments, the fiberization of PTFE is carried out at a temperature of 100° C. or higher, at a temperature of 130° C. or higher, or at a temperature of 150° C. or higher. As shown in the Examples described later, carrying out the fiberization of PTFE at a temperature of 50° C. or higher improves the tensile strength of the electrode film. The reason for this is thought to be that, for example, the fiberization of PTFE is promoted, and also the PVdF is softened or melted and at least a part of the fiberized PTFE is made to adhere to the active material particles by the softened or melted PVdF.

In some embodiments, the fiberization of PTFE is carried out at a temperature of 200° C. or lower, at a temperature of 180° C. or lower, or at a temperature of 160° C. or lower. As shown in the Examples described later, carrying out the fiberization of PTFE at a temperature of 200° C. or lower enables the tensile strength of the electrode film to be suitably maintained. The reason for this is thought to be that, for example, the softening or melting of PVdF occurs moderately, which allows the fiberized PTFE to moderately adhere to the active material particles, thereby maintaining suitable elasticity of the resultant electrode film.

When the mixture is formed into a film in Process 3, the thickness of the formed product is not limited in particular, and can be adjusted in accordance with the desired thickness of the electrode film. For example, the thickness of the formed product (i.e., the thickness of the electrode film) can be selected from a range of 50 μm to 300 μm.

From the perspective of increasing the tensile strength of the electrode film, in some embodiments, the fiberized PTFE obtained in Process 3 is present in the electrode film at a high density. For example, in some embodiments, when a straight line having a length of 20 μm is placed at any position on an image of a cross-section of the electrode film, the count of strands of fibrous PTFE intersecting with the straight line is no less than five. In some embodiments, the count of strands of fibrous PTFE fibers intersecting with a straight line having a length of 20 μm is no less than 10, or no less than 20. In some embodiments, the image of the cross section of the electrode film includes at least one region in which the count of strands of fibrous PTFE intersecting a straight line having a length of 20 μm is no less than five, no less than 10, or no less than 20. In some embodiments, the dimensions of the image of the cross section of the electrode film are 40 μm or more in a width direction and 40 μm or more in a thickness direction. Cross-sectional images of the electrode film can be obtained using known techniques such as transmission electron microscope (TEM) or the like. The magnification of the image of the cross section of the electrode film is not limited in particular, as long as the fiberized PTFE can be sufficiently observed.

The electrode film obtained by the method according to the present disclosure may be integrated with the current collector. The method for integrating the electrode with the current collector is not limited in particular, and can be carried out using known techniques. For example, the electrode film and the current collector may be pressure-bonded together using a roll press machine, a plate press machine, or the like. The material of the current collector is not limited in particular, and can be selected from known materials such as aluminum, copper, nickel, titanium, stainless steel, and so forth.

### Electrode Film

The electrode film according to the present disclosure is an electrode film including active material particles, PVdF adhering to the active material particles, and fibrous PTFE.

The electrode film of the present disclosure can be manufactured, for example, by the electrode film manufacturing method that is described above. For details and forms of the electrode film according to the present disclosure, and each material contained in the electrode film, details and forms of the electrode film manufactured by the electrode film manufacturing method described above, or each material contained in the electrode film, can be referenced.

In some embodiments of the electrode film, at least a portion of the fibrous polytetrafluoroethylene is adhered to the active material particles.

The tensile strength of the electrode film is not limited in particular, and can be selected depending on the type of battery to which the electrode film is applied, and so forth. For example, the tensile strength of the electrode film may be 0.4 MPa or higher, 0.5 MPa or higher, or 0.6 MPa or higher. In an electrode film having a tensile strength of 0.5 MPa or higher, damage such as cracks is less likely to occur during manufacturing of the electrode film. The tensile strength of the electrode film is measured by the method described in the Examples.

### Battery

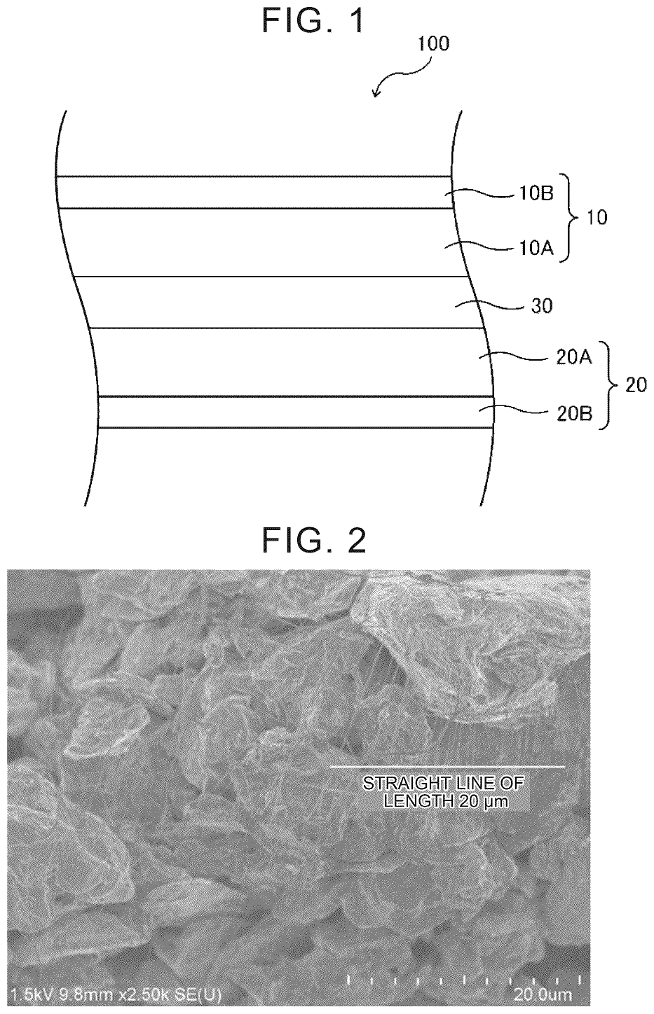

The battery of the present disclosure includes the electrode film according to the present disclosure described above. The battery according to the present disclosure includes, for example, an electrode body having a laminated structure including a cathode, an anode, and a separator disposed between the cathode and the anode as necessary. An example of the laminated structure of the electrode body is illustrated schematically in FIG. 1. A laminated structure 100 of the electrode body illustrated in FIG. 1 is made up of a cathode 10, an anode 20, and a separator 30 disposed between the cathode 10 and the anode 20. The cathode 10 is made up of a cathode active material layer 10A and a cathode current collector 10B. The anode 20 is made up of an anode active material layer 20A and an anode current collector 20B.

The electrode film is included in the battery as the active material layer of the electrode. The electrode film may be included in the battery as either the cathode active material layer or the anode active material layer, or may be included in the battery as both the cathode active material layer and the anode active material layer.

The type of battery of the present disclosure is not limited in particular, and can be selected from batteries such as lithium-ion secondary batteries (including liquid batteries and all-solid-state batteries), lead acid batteries, nickel-metal hydride batteries, nickel-cadmium batteries, nickel-iron batteries, nickel-zinc batteries, silver oxide-zinc batteries, cobalt titanium-lithium secondary batteries, sodium-ion secondary batteries, and so forth.

When the battery includes a separator, the type of the separator is not limited in particular, and a known separator can be used. Specific examples of the separator include nonwoven fabrics, cloths, microporous films, and so forth, of which the primary component is polyolefins such as polyethylene, polypropylene, and so forth. The thickness of the separator is not limited in particular, and may be selected from a range of 5 μm to 50 μm, for example.

While the present disclosure will be described in further detail below with reference to Examples, the present disclosure is not limited to these Examples.

### Fabricating Electrode Film

Graphite particles (20 μm in volume average particle diameter, 92.2 parts by mass) serving as active material particles and PVdF (4.8 parts by mass) were placed in an MP mixer (Nippon Coke & Engineering Co., Ltd.), and compositing processing was carried out under conditions of 10,000 rpm for 2 minutes to cause adhesion of the PVdF to the surfaces of the graphite particles.

PTFE (3 parts by mass) was further added to the MP mixer following the compositing processing, and mixed under conditions of 300 rpm for 180 seconds. Next, the mixture was further mixed under conditions of 5,000 rpm for 500 seconds so as to form granules in a state in which the graphite particles were bound by the fiberized PTFE.

The mixture containing the granules was subjected to rolling processing (linear pressure of 0.4 t/cm, no coolant) using a roll press machine to perform fiberization of the PTFE and to further form into a film, thereby obtaining an electrode film. Such rolling processing was carried out at each of temperatures of 25° C., 50° C., 100° C., 150° C., 160° C., 170° C., 180° C. and 200° C.

### Measurement of Tensile Strength

Test pieces having the dimensions shown in Table 1 were fabricated from the electrode film that was obtained. The test piece was subjected to a tensile test at a speed of 2 mm/s using a texture analyzer (EKO Instruments Co., Ltd.). The tensile strength was calculated from a load greatest value (F) applied to the test piece according to the following Expression. The results are shown in Table 1.

$$Tensile strength ( MPa ) = F ( g ) 0.0098 / ( thickness ( mm ) \times width ( mm ) )$$

TABLE 1

| | Temper- | Thick- | | | | Tensile | |
|---|---|---|---|---|---|---|---|
| Test | ature | ness | Width | Length | F | strength | |
| pieces | (° C.) | (μm) | (mm) | (mm) | (g) | MPa | Average |
| 1-1 | 25 | 221 | 35 | 31 | 46 | 0.06 | 0.08 |
| 1-2 | | 273 | 35 | 31 | 85 | 0.09 | |
| 1-3 | | 223 | 35 | 31 | 79 | 0.10 | |
| 2-1 | 50 | 208 | 35 | 31 | 100 | 0.13 | 0.16 |
| 2-2 | | 213 | 35 | 31 | 131 | 0.17 | |
| 2-3 | | 210 | 35 | 31 | 137 | 0.18 | |
| 3-1 | 100 | 213 | 35 | 31 | 299 | 0.39 | 0.27 |
| 3-2 | | 213 | 35 | 31 | 111 | 0.15 | |
| 3-3 | | 217 | 35 | 31 | 207 | 0.27 | |
| 4-1 | 150 | 204 | 35 | 17 | 403 | 0.55 | 0.54 |
| 4-2 | | 201 | 35 | 26 | 324 | 0.45 | |
| 4-3 | | 212 | 35 | 31 | 477 | 0.63 | |
| 5-1 | 160 | 195 | 35 | 31 | 773 | 1.11 | 0.88 |
| 5-2 | | 215 | 35 | 31 | 563 | 0.73 | |
| 5-3 | | 210 | 35 | 31 | 589 | 0.79 | |
| 6-1 | 170 | 215 | 35 | 31 | 636 | 0.83 | 0.79 |
| 6-2 | | 225 | 35 | 31 | 673 | 0.84 | |
| 6-3 | | 210 | 35 | 31 | 532 | 0.71 | |
| 7-1 | 180 | 205 | 35 | 31 | 468 | 0.64 | 0.68 |
| 7-2 | | 215 | 35 | 31 | 592 | 0.77 | |
| 7-3 | | 220 | 35 | 31 | 506 | 0.64 | |
| 8-1 | 190 | 198 | 35 | 31 | 459 | 0.65 | 0.69 |
| 8-2 | | 191 | 35 | 31 | 442 | 0.65 | |
| 8-3 | | 205 | 35 | 31 | 566 | 0.77 | |
| 9-1 | 200 | 195 | 35 | 31 | 430 | 0.62 | 0.51 |
| 9-2 | | 193 | 35 | 31 | 269 | 0.39 | |
| 9-3 | | 205 | 35 | 31 | 382 | 0.52 | |

As shown in Table 1, the electrode films obtained by carrying out rolling processing at a temperature of 50° C. or higher exhibited higher tensile strength than the electrode films obtained by carrying out rolling processing at a temperature of less than 50° C. Among the electrode films obtained by carrying out rolling processing at a temperature of 50° C. or higher, the electrode films obtained by carrying out the rolling processing at temperatures of 160° C. to 190° C. exhibited particularly high tensile strength.

### Electron Microscope Observation of Electrode Film

FIG. 2 is an SEM image of a cross-section of the electrode film obtained by carrying out rolling processing at 150° C. As can be seen in FIG. 2, fibrous PTFE was observed in the cross-section of the electrode film obtained by carrying out rolling processing at 150° C., and also part of the PTFE was observed to be adhered to the graphite particles. Moreover, the coverage of the surfaces of the graphite particle by PVdF as measured by EDX was 10% or more. The SEM image in FIG. 2 contained an area in which 20 or more fiberized PTFE strands intersecting a straight line 20 μm in length were observed.

What is claimed is:

1. An electrode film manufacturing method, comprising:
performing adhesion of polyvinylidene difluoride to active material particles;
mixing the active material particles, to which the polyvinylidene difluoride is adhered, with polytetrafluoroethylene to obtain a mixture; and
fiberizing the polytetrafluoroethylene in the mixture, wherein:
the fiberizing is carried out at a temperature of 50° C. or higher; and
the mixture does not contain a solvent.

2. The electrode film manufacturing method according to claim 1, wherein the fiberizing is carried out at a temperature of 100° C. or higher.

3. The electrode film manufacturing method according to claim 1, wherein the fiberizing is carried out at a temperature of 200° C. or lower.

4. The electrode film manufacturing method according to claim 1, wherein the fiberizing is carried out at a temperature of 180° C. or lower.

5. The electrode film manufacturing method according to claim 1, wherein the fiberizing includes fashioning the mixture into a film.

6. The electrode film manufacturing method according to claim 1, wherein an amount of the polyvinylidene difluoride relative to an amount of the active material particles is no less than 1% by mass and no more than 10% by mass relative to 100 parts by mass of the active material particles.

7. The electrode film manufacturing method according to claim 1, wherein an amount of the polytetrafluoroethylene relative to an amount of the active material particles is no less than 1% by mass and no more than 10% by mass relative to 100 parts by mass of the active material particles.

8. An electrode film, comprising:
active material particles;
polyvinylidene difluoride adhering to the active material particles; and
polytetrafluoroethylene that is fibrous.

9. The electrode film according to claim 8, wherein a count of strands of polytetrafluoroethylene that is fibrous, intersecting a straight line of a length of 20 μm situated at any position on an image of a cross-section of the electrode film, is no less than five.

10. The electrode film according to claim 9, wherein the count of the strands of polytetrafluoroethylene that is fibrous, intersecting the straight line, is no less than 20.

11. The electrode film according to claim 8, wherein at least a part of the polytetrafluoroethylene that is fibrous adheres to the active material particles.

12. The electrode film according to claim 8, wherein coverage of surfaces of the active material particles by the polyvinylidene difluoride is no less than 5%.

13. A battery, comprising: the electrode film according to claim 8.
